(19) United States
(12) Patent Application Publication
(10) Pub. No.: US 2026/0158734 A1
(43) Pub. Date: Jun. 11, 2026

(54) MOLDING STRUCTURE OF ORNAMENT

(71) Applicant: KAI-MOU TSAI, TAIPEI CITY (TW)

(72) Inventor: KAI-MOU TSAI, TAIPEI CITY (TW)

(21) Appl. No.: 18/976,463

(22) Filed: Dec. 11, 2024

(51) Int. Cl. B29C 51/18; A45D 8/00; B29C 51/30; B29C 51/42; B29L 31/00; B44C 3/04

(52) U.S. Cl. CPC B29C 51/18; A45D 8/004; B29C 51/30; B29C 51/42; B44C 3/04; B29K 2995/0046; B29K 2995/0077; B29L 2031/718; B29L 2031/722; B29L 2031/743

(57) ABSTRACT

A molding structure of ornament includes a molding mold set composed of a larger first molding mold and a same shape of smaller second molding mold. By placing an originally circular spiral wire elastic wrapping band in the gap between the first and second molding molds, then heating the circular spiral wire elastic wrapping band and then cooling the heated circular spiral wire elastic wrapping band, the circular spiral wire elastic wrapping band is formed into the same shape as the molding mold set. A base plate with a plurality of upright fixing rods thereon is further provided for holding a circular spiral wire elastic wrapping band made of thermoplastic material for heating and then cooling, so that the circular spiral wire elastic wrapping band is thermoplasticized into the desired shape with sharp corners to be used for hair ornaments, bracelets, and key chain pendants.

### BACKGROUND OF THE INVENTION

### 1. Field of the Invention

The present invention relates to a molding structure of an ornament, and in particular to a kind of spiral wire ornament of the desired shape that is formed by placing a circular spiral wire elastic wrapping band into a molding mold, heating it with hot water or placing it in an oven, and cooling it after heating. The spiral wire ornament thus formed can be used for hair accessories, bracelets, and key chain pendants.

### 2. Description of the Related Art

Conventional spiral hair accessories are made by winding a plastic wire around a round rod and heating it to form a spiral wire. The spiral wire is cut into a desired length and then the two ends of each spiral wire are processed and bonded to form a spiral hair accessory. However, most known products are only circular, such as the circular spiral wire elastic wrapping band 2 before heat forming as shown in FIG. 1 of the present invention. And because the plastic wires used have material elasticity, most of them can only present a round shape, and cannot enhance the decorative effect. Instead, they can only be changed in wire color, but can only present a round shape, and the practicality and decorative effect are not good.

Furthermore, it is known that after the plastic wire formed into a spiral wire 4 for making a spiral ornament, the two ends of the spiral wire 4 are processed and bonded to form a spiral coil finished product. However, the end surfaces of the spiral wire 4 are generally straight cut surfaces 41 or oblique cut surfaces 42 (as shown in FIG. 21 and FIG. 22). However, no matter the straight cut surfaces 41 or the oblique cut surfaces 42, since there is no matching design, they are only bonded together by the adhesive force of the adhesive. Therefore, when in use, they are very likely to break and be damaged due to excessive tension or aging and deterioration of the adhesive.

### SUMMARY OF THE INVENTION

The main object of the present invention is to place a circular spiral wire elastic wrapping band in the gap between first and second molding molds of the same shape and heat it, so that the original circular spiral wire elastic wrapping band can be molded into the same shape as the molding mold set, and then various shapes of ornaments can be made according to the required shapes, and can be used for hair decorations, bracelets, key chain pendants, etc.

Another object of the present invention is to arrange multiple fixing rods with equal or unequal spacing on a base plate, in addition to forming by the first and second molding molds of the preset shapes, if the formed ornaments need other sharp corners. A circular spiral wire elastic wrapping band made of thermoplastic material is hooked onto the fixing rods to form a specific shape with sharp corners. After heating, the ornaments of the desired shape can be formed and can be used for hair ornaments, bracelets, and key chain pendants. The spiral wire elastic wrapping band is positioned to form the desired shape with sharp corners, and then heated with hot water or placed in an oven for heating. After heating, it is cooled with water or at room temperature to form an ornament of the desired shape with sharp corners.

To achieve these and other objects of the present invention, the molding structure of ornament comprises a molding mold set. The molding mold set is composed of a first molding mold with a larger outer diameter and a second molding mold with a smaller outer diameter, The first molding mold and the second molding mold have the same shape. The first molding mold has a space formed therein. The first molding mold and the second molding mold define a gap therebetween after the second molding mold is placed in the first molding mold. By placing an originally circular spiral wire elastic wrapping band in the gap between the first molding mold and the second molding mold, then heating the originally circular spiral wire elastic wrapping band and then cooling the heated the circular spiral wire elastic wrapping band, the originally circular spiral wire elastic wrapping band is formed into the same shape as the molding mold set.

In addition, the molding structure of ornament further comprises a base plate and a plurality of fixing rods for holding a circular spiral wire elastic wrapping band for heating the circular spiral wire elastic wrapping band into a predetermined shape with sharp corners. The fixing rods are vertically mounted on said base plate with equal or unequal spacing and arranged in the required pattern according to the required shape; then, a circular spiral wire elastic wrapping band made of thermoplastic material is hooked onto the fixing rods to form a specific shape, and then heated and cooled. so that the circular spiral wire elastic wrapping band is thermoplasticized into the desired shape to be used for hair ornaments, bracelets, and key chain pendants. The heating method can be heating with hot water or placing in an oven for heating, and then cooling with water or cooling at room temperature to form the desired finished product.

### BRIEF DESCRIPTION OF THE DRAWINGS

FIG. 1 is a three-dimensional exploded diagram of one of the preferred embodiments of the present invention.

FIG. 2 shows an implementation example of placing a circular spiral wire elastic wrapping band into a molding mold.

FIG. 3 is a three-dimensional exploded view of an embodiment of the present invention in which a set of long first and second molding molds is used and more than one circular spiral wire elastic wrapping band is placed between the first and second molding molds to produce multiple finished products.

FIG. 4 is a partial three-dimensional diagram of an embodiment of the present invention in which a plurality of holes are provided on the first or second molding mold.

FIG. 5 is a partial three-dimensional diagram of an embodiment of the present invention in which a plurality of long slots are provided on the first or second molding mold.

FIG. 6 is a three-dimensional diagram of a finished product in which the circular spiral wire elastic wrapping band is molded into a heart-shaped finished product using the molding mold.

FIG. 7 is a three-dimensional diagram of a finished product in which the circular spiral wire elastic wrapping band is molded into a triangle-shaped finished product using the molding mold.

FIG. 8 is a three-dimensional diagram of a finished product in which the circular spiral wire elastic wrapping band is molded into a square-shaped finished product using the molding mold.

FIG. 9 is a three-dimensional diagram of an embodiment of the present invention in which one or more circular spiral wire elastic wrapping bands are hooked onto outer and inner fixing rods.

FIG. 10 is a schematic diagram of an embodiment of the invention in which the elasticity of the circular spiral wire elastic wrapping band itself causes some rebound after heat forming and removal from the outer and inner fixing rods.

FIG. 11 is a front view of an embodiment of the invention in which the elasticity of the circular spiral wire elastic wrapping band itself causes some rebound after heat forming and removal from the outer and inner fixing rods.

FIG. 12 is a three-dimensional diagram of a finished product of the present invention after processing and shaping.

FIG. 13 is a side view of the hooked portions of the two ends of the circular spiral wire elastic wrapping band of the present invention.

FIG. 14 is a side view of an alternate form of the hooked portions of the two ends of the circular spiral wire elastic wrapping band of the present invention.

FIG. 15 is a first example of an ornament made according to the present invention to be used for Halloween.

FIG. 16 is a second example of an ornament made according to the present invention to be used for Halloween.

FIG. 17 is a third example of an ornament made according to the present invention to be used for Halloween.

FIG. 18 is a first example of an ornament made according to the present invention to be used for Christmas.

FIG. 19 is a second example of an ornament made according to the present invention to be used for Christmas.

FIG. 20 is a third example of an ornament made according to the present invention to be used for Christmas.

FIG. 21 is a side view of a straight cut surface of both ends of a conventional spiral wire.

FIG. 22 is a side view of an oblique cut surface of both ends of a conventional spiral wire.

### DETAILED DESCRIPTION OF THE PREFERRED EMBODIMENT

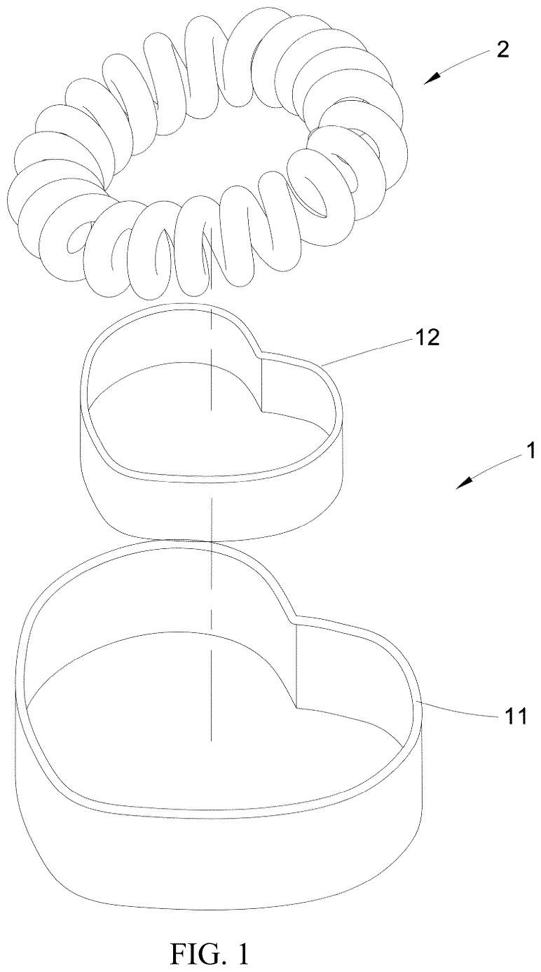

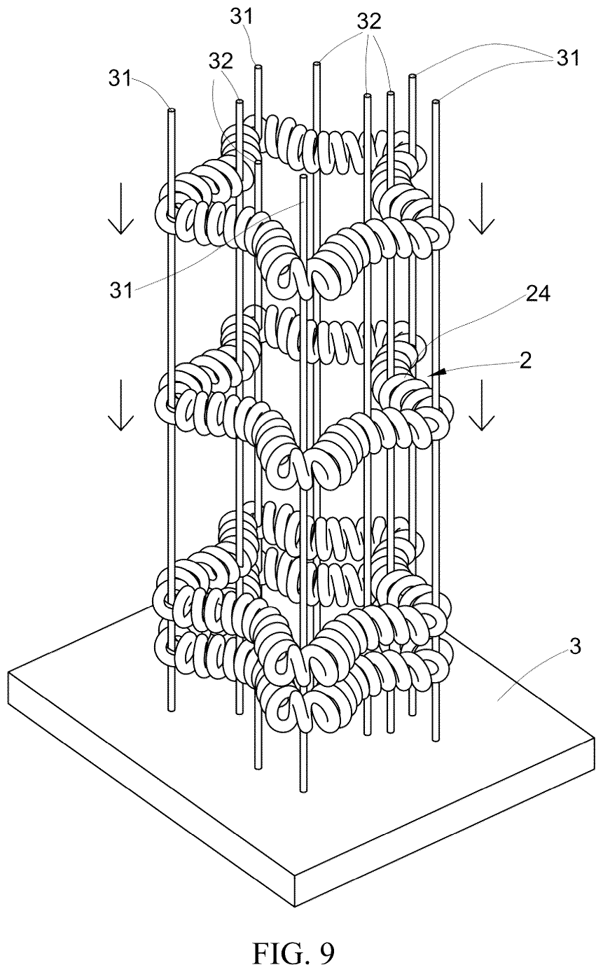

The molding structure of ornament of the present invention includes using a molding mold set 1 (as shown in FIG. 1), a base plate 3 and a combination of fixing rods 31 and 32 to position and make the circular spiral wire elastic wrapping band 2 to form a desired shape with sharp corners 25 (as shown in FIG. 9), and then heating it with hot water or placing it in an oven for heating, and then cooling it with water or at room temperature to form the desired ornament.

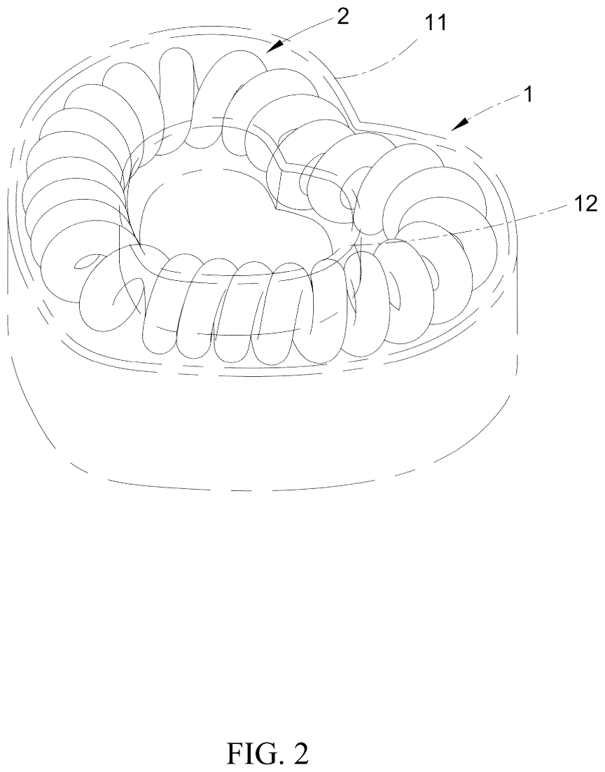

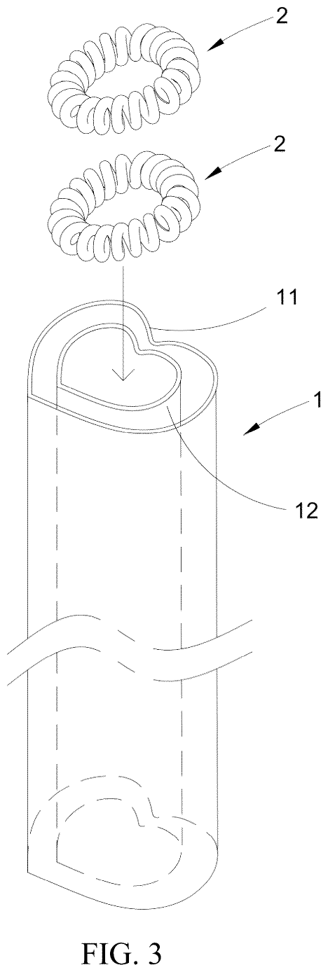

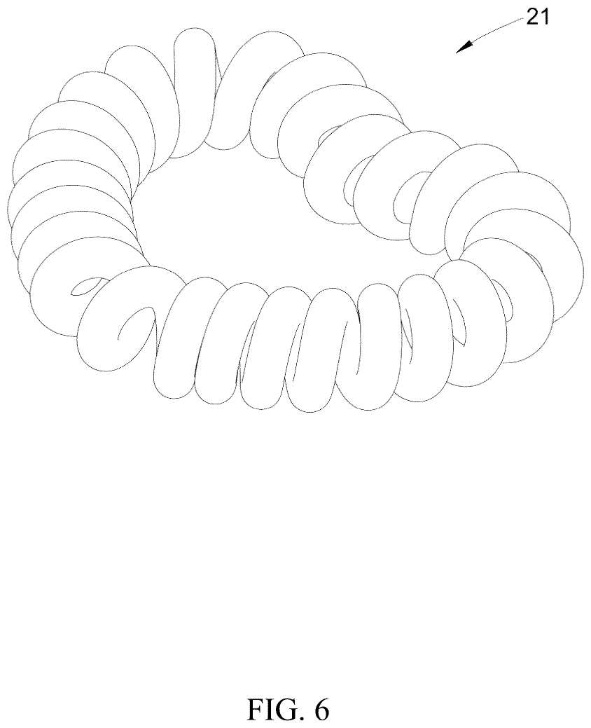

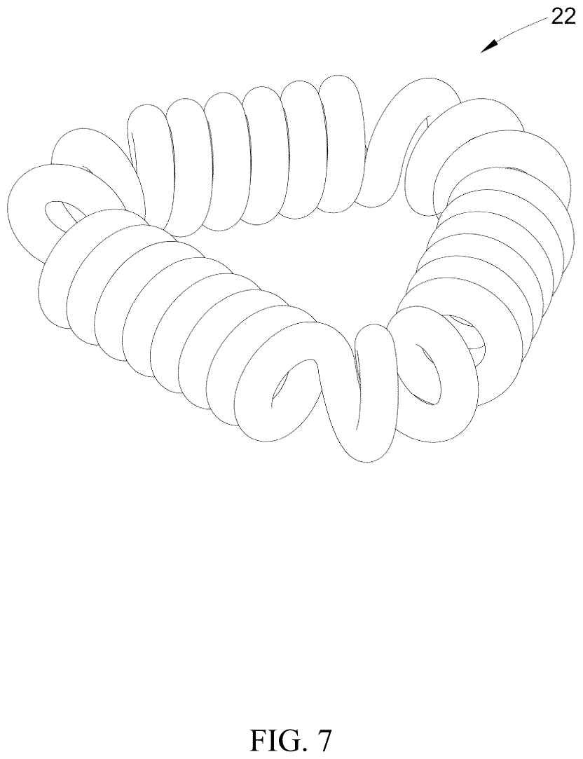

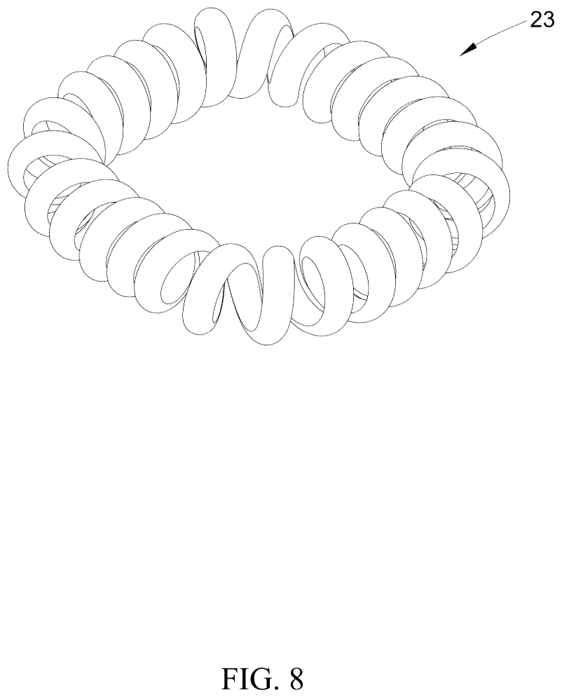

Please refer to FIGS. 1, 2, and 3, which are examples of the molding structure of an ornament of the present invention. The molding structure of the ornament comprises a molding mold set 1. The molding mold set 1 is composed of a first molding mold 11 with a large outer diameter and a second molding mold 12 with a small outer diameter. The first and second molding molds 11 and 12 are of the same shape. A space is formed in the first molding mold 11, and a gap is formed between the first molding mold 11 and the second molding mold 12 after the combination. By placing at least one originally circular spiral wire elastic wrapping band 2 in the gap between the first and second molding molds 11 and 12 and heating them, the originally circular spiral wire elastic wrapping band 2 can be molded into the same shape as the molding mold set 1, and then various molding mold sets 1 of different shapes can be made according to the required shapes, so that various ornaments of different shapes can be produced, such as the heart-shaped finished product 21 (as shown in FIG. 6), the triangle-shaped finished product 22 (as shown in FIG. 7) and the square-shaped finished product 23 (as shown in FIG. 8). These finished products can be used for hair decoration, bracelet and key chain pendant and the like. In addition, the space formed in the first molding mold 11 is in the same shape as its outer edge.

The heating method can be 70˜85° C. hot water heating, or placed in an oven to heat at 100˜130° C. After heating with water and in the oven, it can be cooled with water or at room temperature to form the finished product.

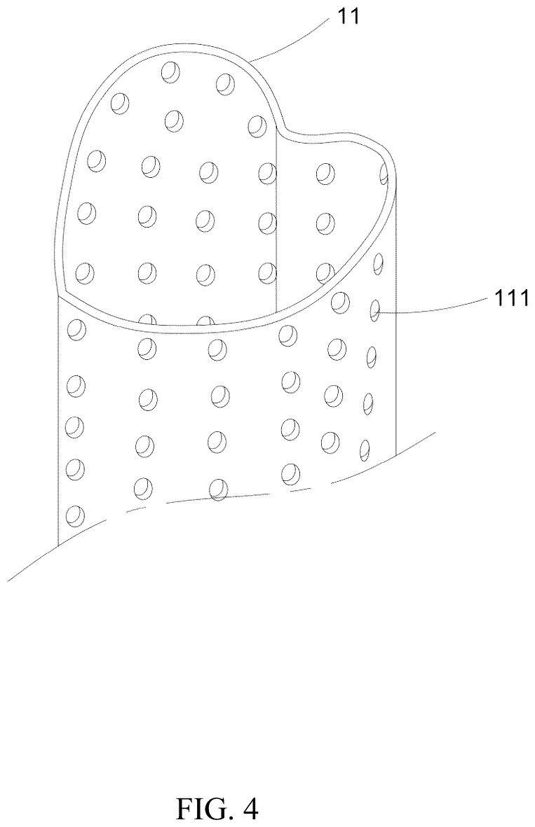

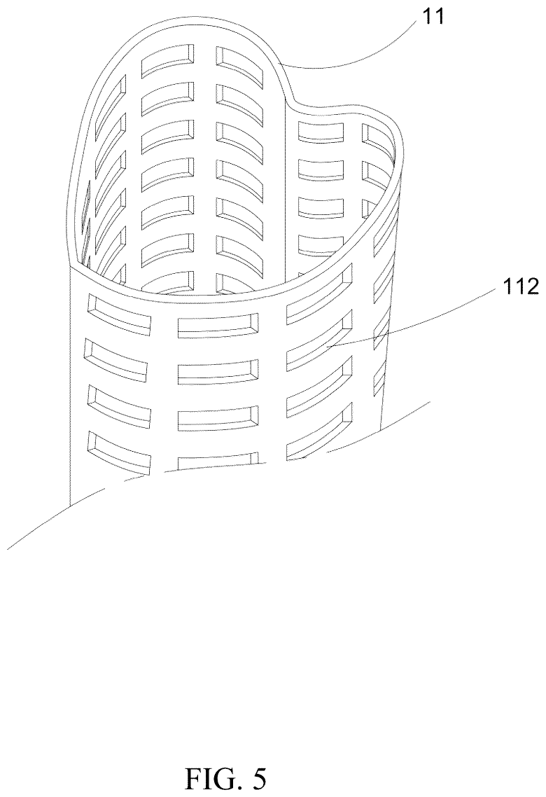

In addition, a plurality of holes 111 or long slots 112 are provided on the first molding mold 11, so that hot water or heat can enter the first molding mold 11 through the plurality of holes 111 or long slots 112, so that the circular spiral wire elastic wrapping band 2 is heated evenly (as shown in FIGS. 4 and 5). A plurality of holes or long slots may also be provided on the second molding mold 12.

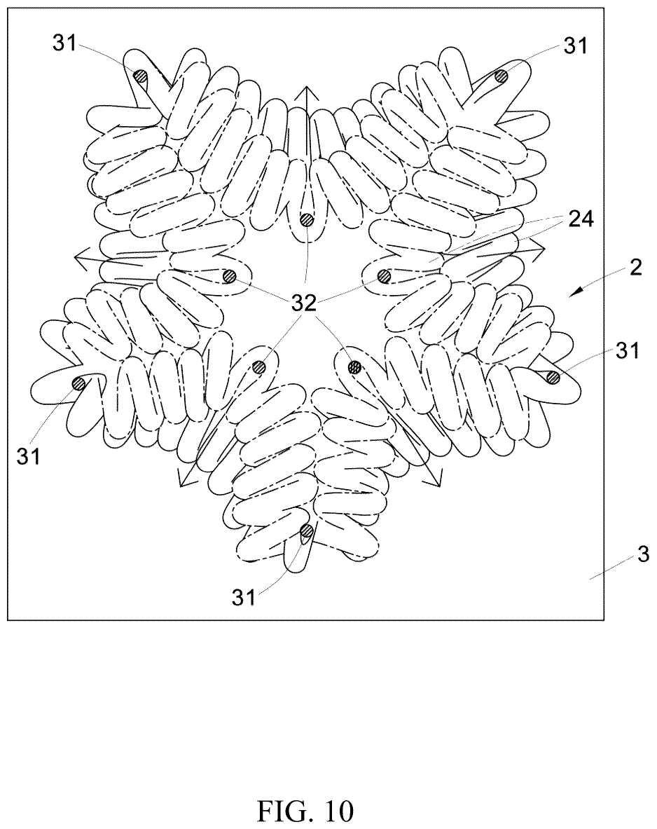

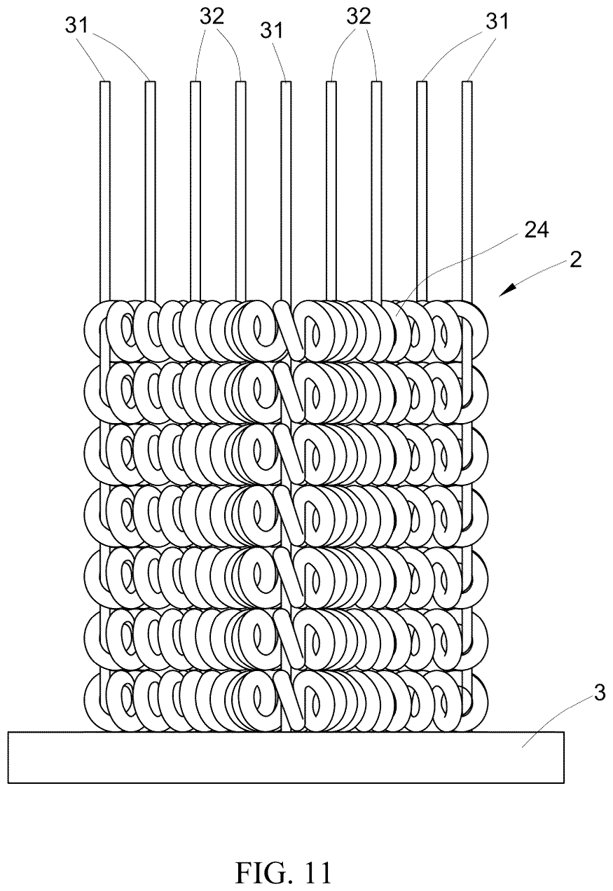

Please refer to FIGS. 9-12, in another embodiment of the present invention, the molding structure of ornament further comprises a base plate 3 and a plurality of fixing rods 31 and 32. In addition to the first and second molding molds 11 and 12 of the preset shapes, if the ornaments to be formed need to have other sharp corners, they can also be formed by combining the base plate 3 and the fixing rods 31 and 32. It mainly can be arranged on the base plate 3 according to the required shape with a plurality of fixing rods 31, 32 with equal or unequal spacing, and a circular spiral wire elastic wrapping band 2 made of thermoplastic material is hooked on the fixing rods 31, 32 to form a specific shape. After heating, the circular spiral wire elastic wrapping band 2 can be thermoplasticized into the required shape of the ornament, and can be used for hair ornaments, bracelets, and key chain pendants.

This case is implemented with a five-pointed star-shaped ornament, which mainly comprises a base plate 3. Taking the center of the base plate 3 as the base point, a plurality of outer ring fixing rods 31 with equal spacing and equidistant from the center of the base plate 3 are provided on the outer ring of the base plate 3, and a plurality of inner ring fixing rods 32 with the same number and equal spacing as the outer ring are provided on the inner ring with the center of the base plate 3 as the base point and the same center. Each inner ring fixing rod 32 is located at a corresponding position between each two adjacent outer ring fixing rods 31.

One circular spiral wire elastic wrapping band 2 made of thermoplastic material is hooked on the outer ring fixing rods 31, and then the portions 24 of the said circular spiral wire elastic wrapping band 2 between each two adjacent outer ring fixing rods 31 is pulled inward and hooked on the inner ring fixing rods 32, and repeat the above procedure to arrange multiple circular spiral wire elastic wrapping bands 2 on the outer ring fixing rods 31 and inner ring fixing rods 32, then heated, so that the original circular spiral wire elastic wrapping bands 2 can be formed into ornaments with a plurality of convex and concave sharp corners 25 (as shown in FIG. 12) that can be used for hair decoration, bracelets, and key chain pendants. The heating method can be heating with hot water or placing in an oven for heating, and then cooling with water or cooling at room temperature to form the desired ornaments.

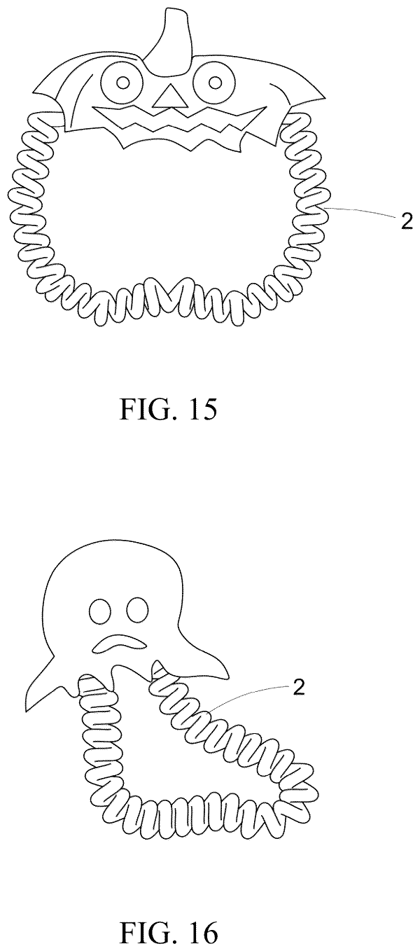

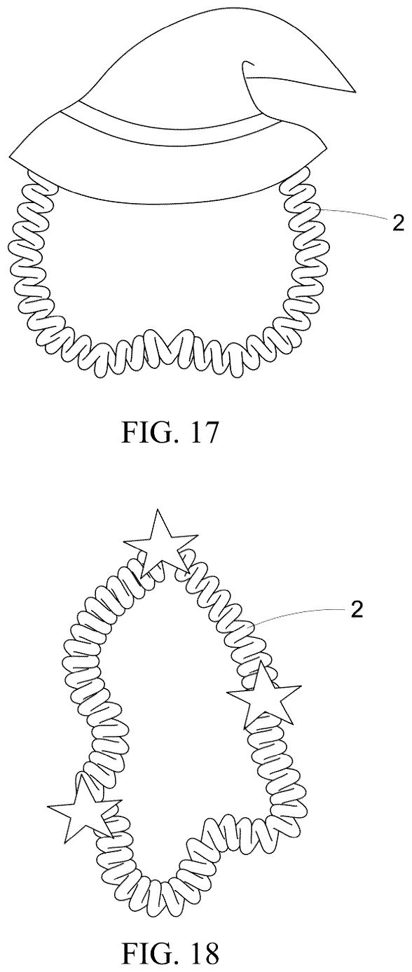

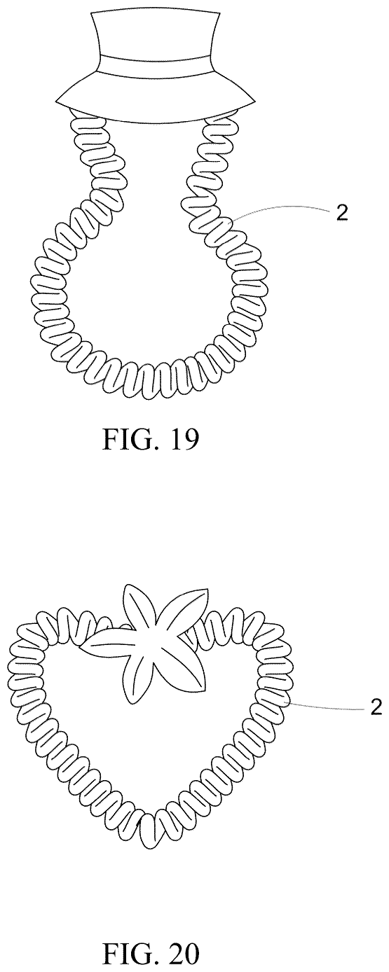

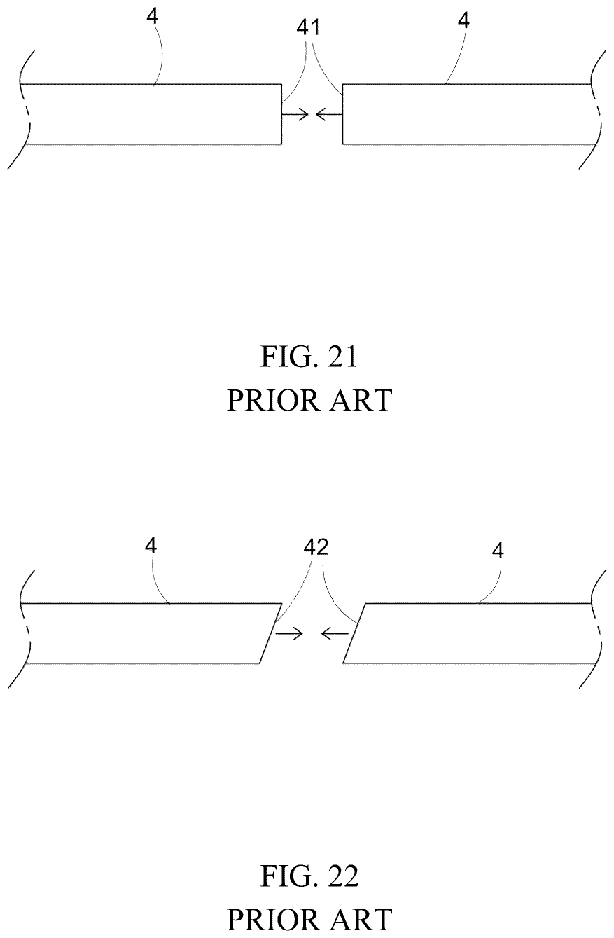

According to the aforementioned forming method using the molding structure of the molding mold 1, the base plate 3 and the fixing rods 31, 32, it is also possible to produce ornaments representing Halloween (as shown in FIGS. 15, 16 and 17) and ornaments representing Christmas (as shown in FIGS. 18, 19 and 20).

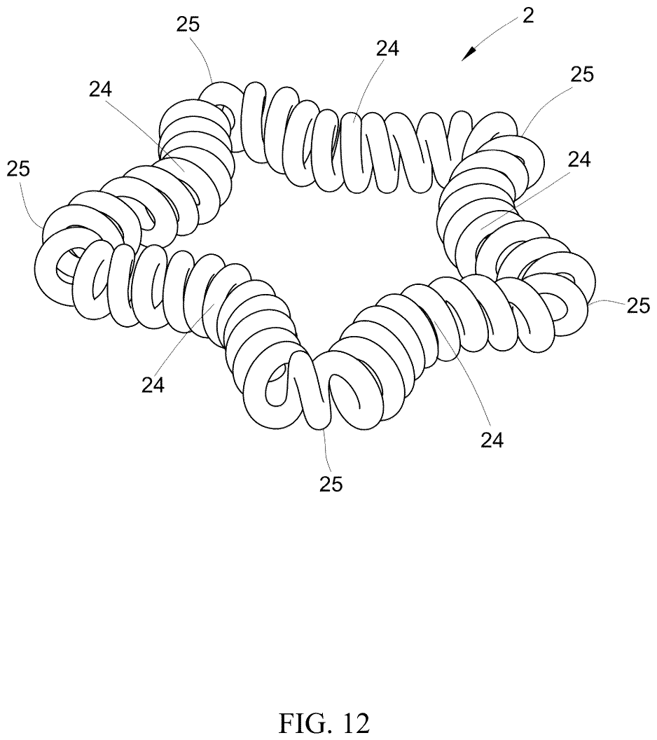

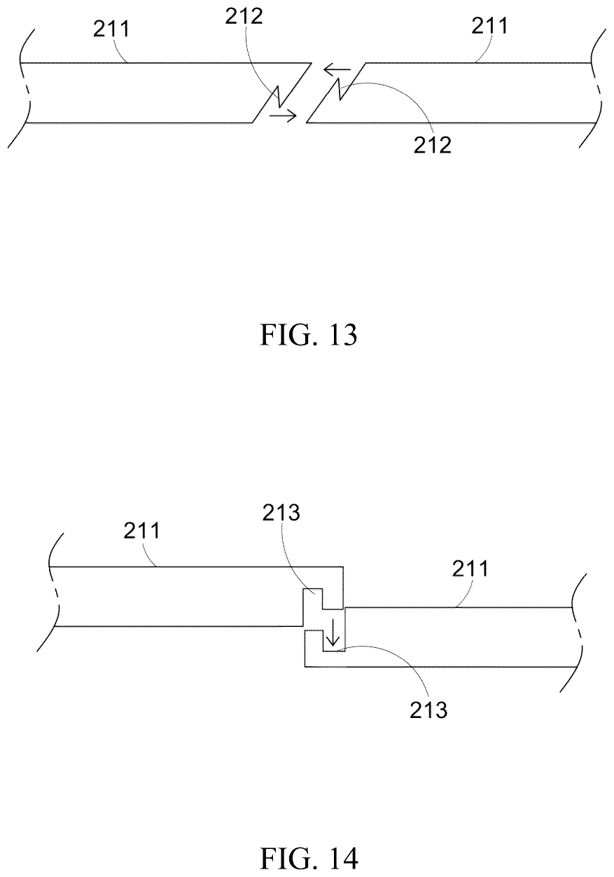

In addition, the cross sections of the wire 211 at both ends of the circular spiral wire elastic wrapping band 2 are formed with hooked portions 212 that can be hooked and assembled with each other. By using adhesive to adhere, and hooked portions 212 to be mutually hooked and fixed, the circular spiral wire elastic wrapping band 2 can withstand a larger tensile force after being formed and has the effect of not being easy to break (as shown in FIG. 13). Furthermore, differently shaped hooked portions 213 that can be hooked and assembled with each other can be formed at the cross sections of both ends of the wire 211 of the circular spiral wire elastic wrapping band 2 to withstand a larger tensile force and have the effect of being difficult to break (as shown in FIG. 14).

In summary, this invention can be used to make molding molds of various shapes according to the required shapes, and can produce ornaments of various shapes. It can be used for hair decorations, bracelets, key chain pendants, etc. It can also be made into ornaments representing Halloween and Christmas, greatly improving practicality and decorative effects.

What is claimed is:

1. A molding structure of ornament, comprising a molding mold set, said molding mold set being composed of a first molding mold with a larger outer diameter and a second molding mold with a smaller outer diameter, said first molding mold and said second molding mold having the same shape, said first molding mold having a space formed therein, said first molding mold and said second molding mold defining a gap therebetween after said second molding mold is placed in said first molding mold, by placing an originally circular spiral wire elastic wrapping band in said gap between said first molding mold and said second molding mold, then heating said originally circular spiral wire elastic wrapping band and then cooling the heated said circular spiral wire elastic wrapping band, said originally circular spiral wire elastic wrapping band is formed into the same shape as said molding mold set.

2. The molding structure of ornament as claimed in claim 1, wherein the cross sections of both ends of the wire material constituting said circular spiral wire elastic wrapping band are formed with hooked portions that are to be hooked and combined with each other, and through the adhesion of an adhesive and the design of said hooked portions being hooked and combined with each other, said circular spiral wire elastic wrapping band is capable of withstanding a large tensile force after being formed and has the effect of being difficult to break.

3. The molding structure of ornament as claimed in claim 1, wherein said first molding mold and said e second molding mold are provided with a plurality of holes for heat to enter said first molding mold and said second molding mold through said plurality of holes, so that said circular spiral wire elastic wrapping band is heated evenly.

4. The molding structure of ornament as claimed in claim 1, wherein the method of heating said circular spiral wire elastic wrapping band is hot water heating, and then water cooling or room temperature cooling is performed.

5. The molding structure of ornament as claimed in claim 1, wherein the method of heating said circular spiral wire elastic wrapping band is to place said circular spiral wire elastic wrapping band in an oven for heating, and then water cooling or room temperature cooling is performed.

6. The molding structure of ornament as claimed in claim 1, further comprising a base plate and a plurality of fixing rods for holding said circular spiral wire elastic wrapping band for heating said circular spiral wire elastic wrapping band into a predetermined shape with sharp corners, said fixing rods being vertically mounted on said base plate with equal or unequal spacing and arranged in the required pattern according to the required shape; a circular spiral wire elastic wrapping band made of thermoplastic material is hooked onto said fixing rods to form a specific shape, and then heated and cooled. so that said circular spiral wire elastic wrapping band is thermoplasticized into the desired shape to be used for hair ornaments, bracelets, and key chain pendants.

7. The molding structure of ornament as claimed in claim 6, wherein the cross sections of both ends of the wire material constituting said circular spiral wire elastic wrapping band are formed with hooked portions that are to be hooked and combined with each other, and through the adhesion of an adhesive and the design of said hooked portions being hooked and combined with each other, said circular spiral wire elastic wrapping band is capable of withstanding a large tensile force after being formed and has the effect of being difficult to break.

8. The molding structure of ornament as claimed in

6. wherein the method of heating said circular spiral wire elastic wrapping band is hot water heating, and then water cooling or room temperature cooling is performed.

9. The molding structure of ornament as claimed in claim 6, wherein the method of heating said circular spiral wire elastic wrapping band is to place said circular spiral wire elastic wrapping band in an oven for heating, and then water cooling or room temperature cooling is performed.
